(19) United States
(12) Patent Application Publication
(10) Pub. No.: US 2025/0267679 A1
(43) Pub. Date: Aug. 21, 2025

(54) TECHNIQUES FOR NON-PUNCTURED CONTROL CHANNEL DESIGN FOR INITIAL ACCESS

(71) Applicant: Lenovo (United States) Inc., Morrisville, NC (US)

(72) Inventors: Karthikeyan Ganesan, Nauheim (DE); Ravi Kuchibhotla, Chicago, IL (US); Ali Ramadan Ali, Kraiburg am Inn (DE)

(21) Appl. No.: 19/197,922

(22) Filed: May 2, 2025

(51) Int. Cl. H04W 72/232; H04W 72/0453

(52) U.S. Cl. CPC H04W 72/232; H04W 72/0453

(57) ABSTRACT

Various aspects of the present disclosure relate to techniques for non-punctured control channel design for initial access. A base station is configured to configure one or more user equipment (UE) to receive common channel transmissions, wherein the one or more UE are of different types that have different threshold bandwidths, identify one or more common channels that have reception channel bandwidths that are less than the threshold bandwidths of the different types of UE, transmit a transmission to the one or more UE in a resource of a common channel of the one or more common channels, and retransmit at least a portion of the transmission in a second resource of a second common channel to one or more UE that have a threshold bandwidth that is less than the reception channel bandwidth of the common channel.

### TECHNICAL FIELD

The present disclosure relates to wireless communications, and more specifically to techniques for non-punctured control channel design for initial access.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

An NE for wireless communication is described. The NE may be configured to, capable of, or operable to configure one or more UE to receive common channel transmissions, wherein the one or more UE are of different types that have different threshold bandwidths, identify one or more common channels that have reception channel bandwidths that are less than the threshold bandwidths of the different types of UE, transmit a transmission to the one or more UE in a resource of a common channel of the one or more common channels, and retransmit at least a portion of the transmission in a second resource of a second common channel to one or more UE that have a threshold bandwidth that is less than the reception channel bandwidth of the common channel.

A processor for wireless communication is described. The processor may be configured to, capable of, or operable to configure one or more UE to receive common channel transmissions, wherein the one or more UE are of different types that have different threshold bandwidths, identify one or more common channels that have reception channel bandwidths that are less than the threshold bandwidths of the different types of UE, transmit a transmission to the one or more UE in a resource of a common channel of the one or more common channels, and retransmit at least a portion of the transmission in a second resource of a second common channel to one or more UE that have a threshold bandwidth that is less than the reception channel bandwidth of the common channel.

A method for wireless communication performed by a NE is described. The method may be configured to, capable of, or operable to configure one or more UE to receive common channel transmissions, wherein the one or more UE are of different types that have different threshold bandwidths, identify one or more common channels that have reception channel bandwidths that are less than the threshold bandwidths of the different types of UE, transmit a transmission to the one or more UE in a resource of a common channel of the one or more common channels, and retransmit at least a portion of the transmission in a second resource of a second common channel to one or more UE that have a threshold bandwidth that is less than the reception channel bandwidth of the common channel.

A UE for wireless communication is described. The UE may be configured to, capable of, or operable to receive a first portion of a transmission from a BS in a resource of a common channel, the UE having a threshold bandwidth that is less than a reception channel bandwidth of the common channel, receive a second portion of the transmission from the BS in a second resource of a second common channel, the second portion of the transmission received on one or more symbols of the second common channel, and combine the first and second portions of the transmission.

A processor for wireless communication is described. The processor may be configured to, capable of, or operable to receive a first portion of a transmission from a BS in a resource of a common channel, the UE having a threshold bandwidth that is less than a reception channel bandwidth of the common channel, receive a second portion of the transmission from the BS in a second resource of a second common channel, the second portion of the transmission received on one or more symbols of the second common channel, and combine the first and second portions of the transmission.

A method for wireless communication performed by a UE is described. The method may be configured to, capable of, or operable to receive a first portion of a transmission from a BS in a resource of a common channel, the UE having a threshold bandwidth that is less than a reception channel bandwidth of the common channel, receive a second portion of the transmission from the BS in a second resource of a second common channel, the second portion of the transmission received on one or more symbols of the second common channel, and combine the first and second portions of the transmission.

### BRIEF DESCRIPTION OF THE DRAWINGS

FIG. 1 illustrates an example of a wireless communications system, in accordance with aspects of the present disclosure.

FIG. 2A illustrates an example of (re) transmitting punctured physical broadcast channel (PBCH) resources, in accordance with aspects of the present disclosure.

FIG. 2B illustrates an example of mapping punctured PBCH resources, in accordance with aspects of the present disclosure.

FIG. 2C illustrates an example of mapping punctured PBCH resources, in accordance with aspects of the present disclosure.

FIG. 2D illustrates an example of (re) transmitting punctured PBCH resources using enhanced PBCH (ePBCH), in accordance with aspects of the present disclosure.

FIG. 3 illustrates an example of a UE, in accordance with aspects of the present disclosure.

FIG. 4 illustrates an example of a processor, in accordance with aspects of the present disclosure.

FIG. 5 illustrates an example of an NE, in accordance with aspects of the present disclosure.

FIG. 6 illustrates a flowchart of a method performed by an NE, in accordance with aspects of the present disclosure.

FIG. 7 illustrates a flowchart of a method performed by a UE, in accordance with aspects of the present disclosure.

### DETAILED DESCRIPTION

Generally, the present disclosure describes systems, methods, and apparatuses for techniques for non-punctured control channel design for initial access. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In wireless networks, such as wireless communications systems that support 5G networks, initial access refers to a process by which a UE, such as a smartphone or an internet of things (IoT) device, establishes a connection with a Next-Generation Node B (gNB), e.g., the 5G base station. This process begins with a cell search procedure followed by a synchronization process, where the UE first scans for available signals transmitted by the gNB and then synchronizes with the strongest detected signal using a primary synchronization signal (PSS) and a secondary synchronization signal (SSS). Once synchronization is achieved, a random-access procedure occurs, allowing the UE to request access to the network via the random-access channel (RACH). This procedure can be either contention-based, where multiple devices compete for access, or contention-free, where access is pre-allocated for specific users, such as emergency services.

Following the random-access procedure, a radio resource control (RRC) connection establishment phase begins. The UE sends an RRC connection request to the gNB, which responds with an RRC connection setup message. The UE then confirms the setup by sending an RRC connection complete message. Once the connection is established, the gNB proceeds with an authentication and security setup, where it authenticates the UE using protocols such as 5G authentication and key agreement (5G-AKA) or EAP-AKA, ensuring secure communication by establishing encryption keys.

Next, the UE capability exchange and registration phase occurs, during which the UE shares its capabilities, such as supported frequency bands and network slicing preferences. It then registers with the 5G Core Network (5GC) through Non-Access Stratum (NAS) signaling. Finally, the session establishment and resource allocation phase ensures that the network assigns the necessary resources for data transmission, creating a Protocol Data Unit (PDU) session that enables internet or service access.

Initial access is an important process in 5G networks as it ensures efficient and secure connectivity between the UE and the network. It supports fast and reliable device registration, which is essential for applications such as autonomous vehicles, industrial IoT, and smart cities. Additionally, it optimizes power consumption, reduces latency, and improves overall network efficiency.

For 6G, configurations using extra-large multiple input, multiple output (XL-MIMO)—such as those with 256 transmit-receive units (TxRUs) and 1024 antenna elements—may require a larger number of synchronization signal blocks (SSBs). Supporting such a high number of SSBs in the upper mid-band frequency range can increase latency and may not be feasible within the current 5 ms SSB burst duration. Assuming two SSBs per slot, approximately 40 SSBs can be transmitted within a 5 ms burst window if the existing NR design is reused. With three SSBs per slot and minimal or no gaps between them, up to ˜60 SSBs could be supported within the same window. However, to accommodate even larger SSB counts—e.g., 256 SSBs-further enhancements in SSB design for XL-MIMO are necessary. Additionally, the association between SSBs and other physical channels, such as the RACH, will need to be reconsidered.

While the NR-defined SSB burst set duration is nominally 5 ms, configurations employing 15 kHz and 30 kHz subcarrier spacing (SCS) typically support the transmission of up to 8 SSBs within approximately 4 ms by mapping 2 SSBs per slot. Likewise, in the case of 120 kHz SCS, a full SSB burst set comprising 64 SSBs can be scheduled within ˜4.5 ms, adhering to the burst structure defined in 3GPP specifications.

To further minimize SSB transmission latency, in one example, a compact SSB design can be utilized wherein consecutive SSBs are transmitted with zero or minimal symbol spacing. In one example, this enables a reduction in total SSB burst duration and allows the gNB to transition to the active cell state earlier. Under such a compact structure, the complete transmission of 8 or 64 SSBs may be completed in less than 3 ms, depending on the SCS and scheduler optimization.

In NR, the SSB burst set occupies a duration of 5 ms-equivalent to half of a radio frame—and can be transmitted either in the first or second half of the frame, as indicated by the half-frame indicator field in the master information block (MIB). The default SSB burst periodicity for UEs during initial access is 20 ms; however, the actual SSB periodicity applicable in connected mode is signaled via System Information Block Type 1 (SIB1).

In one example, the maximum number of candidate SSB transmissions within an SSB burst set is determined by the operating frequency range and the configured SCS. Specifically, for frequency range 1 (FR1), the maximum number of SSBs per burst is 4 or 8, depending on the SCS (typically 15 kHz or 30 kHz), while for frequency range 2 (FR2), up to 64 candidate SSBs can be configured, typically using 120 kHz or 240 kHz SCS as per 3GPP specifications.

In NR, the PSS, SSS, and PBCH may be co-located within a single SSB, occupying four consecutive orthogonal frequency division multiplexing (OFDM) symbols in the time domain. Each SSB spans 240 subcarriers in the frequency domain, equivalent to 20 resource blocks (RBs) at a 15 kHz subcarrier spacing. The PSS is mapped to the first OFDM symbol and occupies 127 contiguous subcarriers. The SSS is positioned in the third OFDM symbol, also spanning 127 subcarriers, and is centered such that it is flanked by 8 unused subcarriers below and 9 unused subcarriers above. The PBCH utilizes the second and fourth OFDM symbols entirely across all 240 subcarriers. Additionally, in the third OFDM symbol-shared with the SSS the PBCH occupies 48 subcarriers below and 48 above the SSS. Consequently, the PBCH spans a total of 576 subcarriers across its mapping: 240 (second symbol)+48+48 (third symbol edges)+240 (fourth symbol).

In 3GPP Release 18, the introduction of the enhanced reduced capability (eRedCap) feature, which includes a set of features to allow low-power devices to operate with reduced hardware and resource requirements while still being able to participate in a 5G network, includes support for 3 MHz NR cells. However, a key challenge emerged due to the existing NR SSB design being originally tailored for a minimum channel bandwidth of 5 MHz. Specifically, each SSB spans 20 physical resource blocks (PRBs), which corresponds to approximately 3.6 MHz of occupied bandwidth assuming a 15 kHz subcarrier spacing. This inherently exceeds the available bandwidth in a 3 MHz system.

To fit the SSB within the constraints of a 3 MHz carrier, the PBCH region that extends above and below the PSS/SSS may be punctured, reducing the effective bandwidth usage to approximately 12 PRBs. This truncation results in degraded PBCH decoding performance and reduced synchronization signal coverage, ultimately leading to coverage and reliability losses for eRedCap UEs compared to legacy NR Rel-15 devices operating in wider bandwidths.

In NR, the PSS, SSS, and PBCH, collectively referred to as the SSB, may be transmitted together as a single unit. Alongside the SSB, Control Resource Set #0 (CORESET #0) is configured to carry the scheduling information for the SIB1. Both SSB and CORESET #0 are typically transmitted with a 20 ms periodicity, which is also the default periodicity for SIB1 transmission.

However, in scenarios involving constrained bandwidth deployments, such as 3 MHz or 5 MHz carriers introduced for eRedCap and similar use cases, the time-frequency resources allocated for CORESET #0 and SIB1 may need to be punctured or restricted. This limitation is due to the reduced spectrum availability, which can result in partial resource mapping and potential degradation in control channel decoding and system information acquisition performance.

Enhanced Mobile Broadband (eMBB) services in NR are typically designed to support a maximum coupling loss (MCL) target of approximately 145 dB, ensuring robust coverage in standard urban and suburban deployment scenarios. In contrast, low power wide area (LPWA) use cases, such as those targeted by RedCap and eRedCap UEs, require significantly deeper coverage. To meet these requirements, in one example, NR aims to support an MCL of up to 164 dB, representing an enhancement of approximately +20 dB over the baseline eMBB coverage. This extended coverage is critical for supporting IoT and low-throughput devices in challenging RF environments, such as deep indoor or remote rural locations.

In the solutions described herein, a unified design approach is proposed for both eMBB and LPWA UEs operating over narrowband carriers of 3 MHz and 5 MHz. In one example, this design targets the configuration of SSBs, CORESET #0, and SIB1, while supporting both 15 kHz and 30 kHz SCS. Rather than relying on conventional channel puncturing, which restricts the physical channel to fit within the narrow bandwidth at the expense of coverage and decoding performance, alternative methodologies are explored to maintain full channel structure and achieve the required link budget and coverage performance. In one example, these approaches aim to provide a harmonized framework that preserves the integrity of the broadcast and control channels while supporting the distinct coverage and capacity requirements of both eMBB and LPWA use cases.

The proposed unified design offers several improvements for both eMBB and LPWA UE operating over 3 MHz and 5 MHz NR carriers. For instance, by avoiding channel puncturing, the full structure of critical channels such as the PBCH and CORESET #0 is preserved, resulting in improved decoding performance and enhanced coverage, which is important for LPWA use cases that require high maximum coupling loss (MCL) targets of up to 164 dB. In one example, this approach also ensures more reliable system information delivery, as the integrity of SIB1 and its associated control signaling is maintained, enabling robust UE initial access even under challenging radio conditions. Furthermore, in one example, the harmonized framework simplifies network and device design by supporting both high-throughput eMBB and deep-coverage LPWA use cases within a single signaling structure. This may improve spectral efficiency in narrowband deployments and minimizes implementation complexity. Finally, in one example, the methodology aligns with the flexibility of the NR standard, offering a scalable solution that can adapt to evolving requirements and potentially guide future standardization efforts.

Aspects of the present disclosure are described in the context of a wireless communications system. Note that one or more aspects from different solutions may be combined.

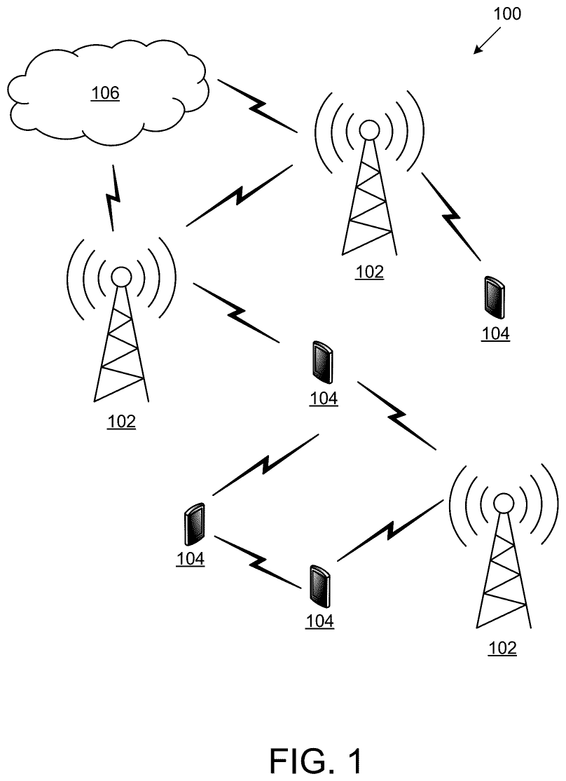

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, u=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one example, the system 100 may be used to implement non-punctured control channel design for initial access. As described in more detail herein, the one or more NEs 102, one or more UEs 104, and CNs 106 in the system 100 may be used to identify one or more punctured resource blocks of a transmission block, determine a bandwidth of a transmission channel for the transmission block, move the one or more punctured resources blocks to one or more symbols of the transmission block in response to the bandwidth of the transmission channel being less than a threshold bandwidth, and transmit the transmission block, which may improve various characteristics of the NEs 102 and/or UEs 104 such as improved initial access procedures, improved signal reliability, improved resource utilization, improved energy efficiency, and improved latency. In this manner, signaling, battery life, and operational efficiencies in the NEs 102 and/or UEs 104 can be enhanced.

In the solutions described herein, a common 6G remaining minimum system information (RMSI) design as part of the common channel(s) is presented to enable simultaneous support for diverse UE types with varying bandwidth capabilities. Specifically, RMSI—including PBCH, system information block type 0 (SIB0), and SIB1—can be transmitted over a wider bandwidth configuration optimized for eMBB UEs, while selectively puncturing portions of these resources to accommodate reduced-bandwidth IoT or LPWA devices. This approach enables a harmonized RMSI framework that leverages a full-bandwidth structure for high-capability UEs and a subset thereof for bandwidth-constrained devices, thereby enhancing flexibility and spectral efficiency. The disclosure further provides the design and operational details for the initial transmission and (re) transmission of punctured RMSI components, ensuring robust system information delivery across heterogeneous device profiles and deployment scenarios.

According to a first example, RMSI is transmitted using PBCH and system information blocks (SIB0, SIB1). In one example, a common 6G RMSI framework accommodates both eMBB UEs and IoT devices with different bandwidth capabilities. For eMBB UEs, the RMSI is transmitted over a wider bandwidth configuration, for example, using 20 PRBs, without the need for resource puncturing. This ensures high data rates and optimal system performance for eMBB UEs.

In contrast, IoT devices with reduced bandwidth capabilities, such as those operating with 12 or 15 PRBs (e.g., less than 20 PRBs), may receive punctured RMSI components (PBCH, SIB0, and SIB1). To mitigate the performance degradation caused by puncturing, an additional transmission in one or more OFDM symbol(s) is made available, containing the necessary resources to soft buffer combine the punctured RMSI data. This retransmission or repeated transmission method enables IoT devices to recover performance losses and ensures that the system can maintain adequate coverage and reliability, even with bandwidth-limited UEs.

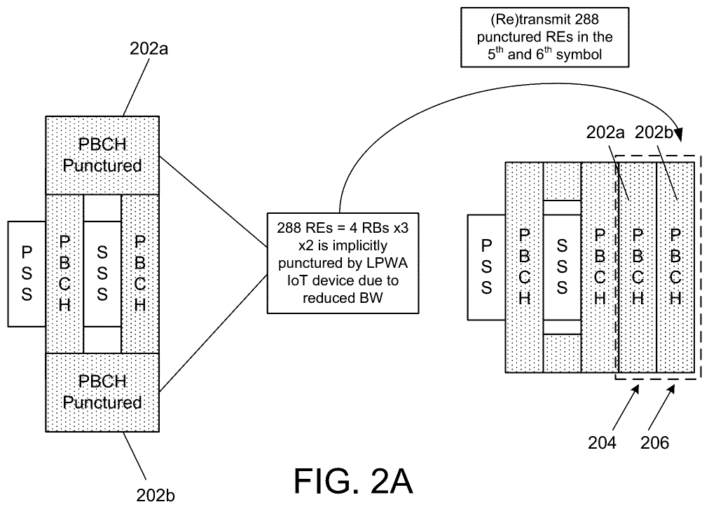

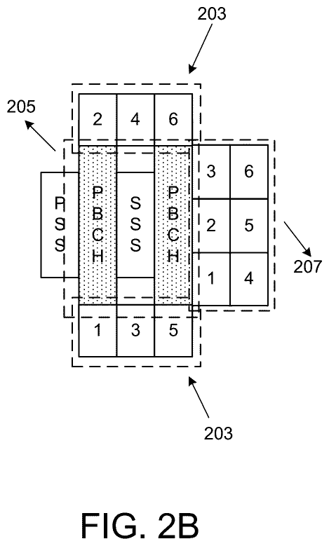

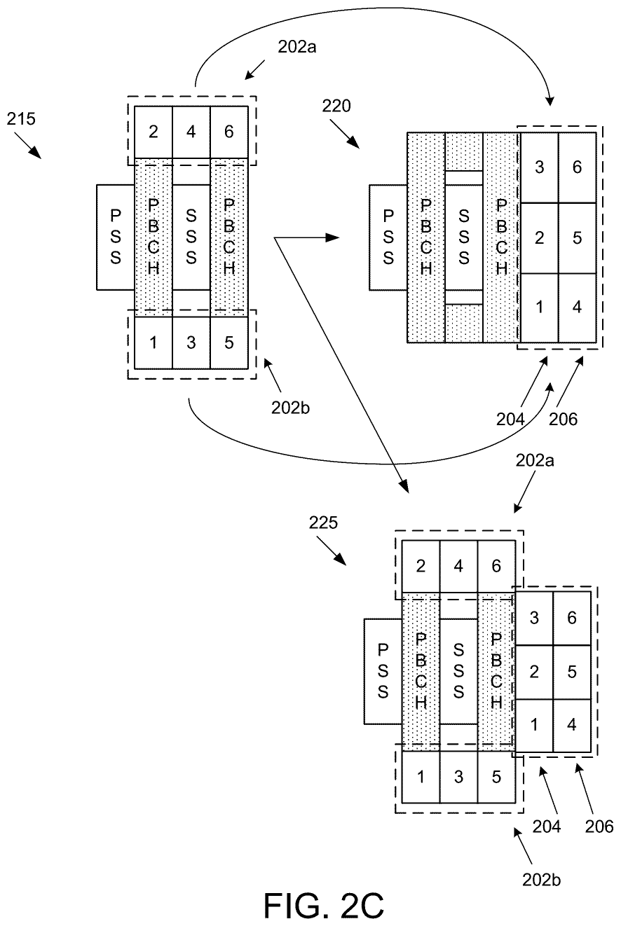

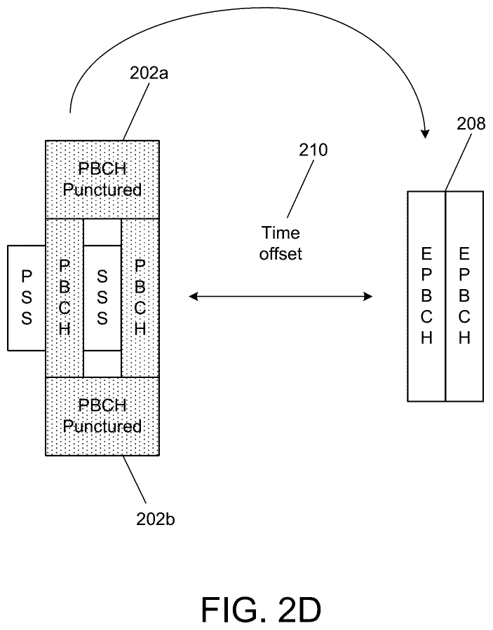

Additionally, as illustrated in FIG. 2C, discussed below, the wideband UE may optionally receive a portion of the RMSI that is retransmitted or repeated, enabling selective soft combining. Alternatively, the wideband UE may disregard the additional one or more OFDM symbols in which the RMSI is retransmitted or repeated. In one example, from the BS transmission perspective, the resources are transmitted as illustrated in FIG. 2C. The BS may transmit the original RMSI, followed by one or more additional symbols that repeat the punctured resources intended for the bandwidth-limited UE.

A bandwidth-limited UE, for example one supporting 12 or 15 PRBs, may receive only a portion of the RMSI due to its limited bandwidth capability. The portion of the RMSI that falls outside the supported bandwidth may be treated by the UE as implicitly punctured from the original RMSI resources. In this context, the term “punctured resources” may refer to resources that are not explicitly punctured by the BS but are effectively excluded at the bandwidth-limited LPWA-IoT receiver. For instance, the BS may transmit using 20 PRBs, while an IoT device supporting only 12 or 15 PRBs will receive only that subset from the total transmission.

The proposed 6G SSB design, in one example, offers a unified solution for both eMBB and LPWA IoT devices. In this design, the SSBs are transmitted over a larger bandwidth, typically greater than 12 or 15 PRBs, to accommodate eMBB UEs. For LPWA-IoT devices with reduced bandwidth capabilities, the SSBs are punctured to fit within the available bandwidth of these IoT UEs, enabling them to receive the SSBs despite the smaller bandwidth.

To mitigate the performance degradation caused by the puncturing, in one example, an additional (re) transmission is provided, utilizing extra symbols. These extra symbols are designed to carry the punctured resources of the PBCH, thereby enabling the IoT UEs to recover the performance losses resulting from the punctured SSBs. This approach may ensure reliable SSB reception across both high-performance eMBB UEs and bandwidth-constrained LPWA-IoT devices, facilitating efficient and flexible system operation.

In the proposed 6G SSB design, in one example, the SSB bandwidth for eMBB UEs is maintained at 20 PRBs, with the corresponding PBCH bandwidth also set to 20 PRBs. In this configuration, the PSS/SSS subcarriers remain fixed at 127 subcarriers for optimal synchronization performance. For IoT UEs operating within constrained bandwidths of either 12 or 15 PRBs, the PBCH resources outside of the allocated 12 or 15 PRBs can be punctured, similar to the approach used in Rel-18 eRedCap. Specifically, in one example, the RB-level puncturing begins by removing resources from the lowest PRBs to the highest PRBs of the first PBCH symbol, continuing in a similar manner for the second and third PBCH symbols. To recover the performance loss caused by the puncturing, these punctured resource blocks may be retransmitted by default periodically with the same periodicity as the SSB or PBCH, ensuring the IoT UEs maintain adequate system information reception and decoding reliability. In one example, a cell may be configured with a minimum supported bandwidth for common channels (e.g., RMSI). In such configurations, the cell may repeat or retransmit common channel resources that fall outside this minimum supported bandwidth using one or more additional OFDM symbols. The additionally transmitted resources of the common channel may be mapped within the minimum supported bandwidth.

In one example, there are several options for retransmission of punctured PBCH resources:

Option 1: Punctured PBCH (Re) Transmission in Extended OFDM Symbols: Punctured PBCH resources may be retransmitted in the 5th and 6th OFDM symbols or alternatively in the 7th or 8th OFDM symbols, immediately following the regular 6G SSB transmission. In this design, the 6G SSBs may consist of either 4 or 6 symbols.

FIG. 2A illustrates an example of (re) transmitting punctured PBCH resources, in accordance with aspects of the present disclosure. As shown in FIG. 2A, punctured resource blocks 202a, 202b are mapped and (re) transmitted in the 5th 204 and 6th 206 OFDM symbols for use in decoding at an LPWA-IoT device. Under this configuration, eMBB UEs can utilize the standard 20 PRBs SSBs with 4 symbols for synchronization and MIB decoding, while IoT UEs with reduced bandwidth, such as 12 or 15 PRBs, can use 6-symbol SSBs and extra symbols to receive the part of the resources of the common channel that was implicitly punctured due to the bandwidth limitation for synchronization and MIB decoding. This allows for flexibility in accommodating both high-capacity and bandwidth-constrained UEs.

Option 2: Configured Time Offset for Retransmission of Punctured Resources: In this option, the OFDM symbol(s) with a configured time offset from the punctured SSB symbols can be used to retransmit the lost resources caused by puncturing. This retransmission allows IoT UEs to acquire the punctured resources while maintaining the same Quality of Channel (QCL) assumption as the regular SSB symbols. The retransmitted resources can then be used by the IoT UE for selective soft demodulator combining, enhancing the decoding reliability despite the initial puncturing.

Option 3: Use of PDSCH for Retransmitting Punctured PBCH Resources: The Physical Downlink Shared Channel (PDSCH) can be utilized to receive the punctured PBCH resources. The Physical Downlink Control Channel (PDCCH) may schedule the PDSCH within the CORESET #0 resources. IoT UEs may be configured to monitor either a new search space or a re-used SIB1 search space with a new configured Radio Network Temporary Identifier (RNTI) to receive the Downlink Control Information (DCI) that schedules the PDSCH, which contains the punctured PBCH resources using the same channel coding as used in the PBCH. In this case, the IoT UE may assume that the code rate and modulation scheme used for the PDSCH transmission are the same as those for the PBCH. Additionally, the IoT UE may be instructed to ignore the Modulation and Coding Scheme (MCS) field in the DCI, or alternatively, the base station may choose not to configure the MCS field in the DCI or use a DCI format that does not include the MCS field.

Option 4: As shown in FIG. 2B, which illustrates an example of mapping punctured PBCH resources, in accordance with aspects of the present disclosure, the BS may be configured to map PBCH resources within the time-frequency grid such that the MIB content 203 for eMBB can be mapped outside the minimum supported bandwidth. In one example, a common portion of the MIB content 205 for eMBB and LPWA-IoT UEs may be mapped within the bandwidth shared by both eMBB and LPWA-IoT UEs. Additionally, MIB content 207 intended specifically for LPWA-IoT devices may be mapped in one or more extra OFDM symbols.

FIG. 2C illustrates an example of mapping punctured PBCH resources, in accordance with aspects of the present disclosure. In one example, the (re) transmission of the PBCH may include transmission of punctured resource blocks 202a, 202b, wherein the resources associated with the (re) transmission of the punctured resource blocks 202a, 202b are mapped in a frequency-prioritized manner followed by time-prioritized manner. In one example, the mapping of the punctured resource blocks 202a, 202b is performed on one or more additional OFDM symbols 204, 206. The mapping, in one example, begins with the lowest-frequency resource element corresponding to the lowest-indexed resource block of the first punctured resource block 202a, 202b, and proceeds in increasing frequency order within the same OFDM symbol 204, 206. Upon exhaustion of available frequency resources within an OFDM symbol 204, 206, the mapping continues in the time domain onto subsequent OFDM symbols 204, 206. For instance, the punctured resource blocks 202a, 202b corresponding to the highest-indexed resource block 202a, 202b of the first punctured PBCH symbol are mapped to the next available higher-frequency resource in the additional OFDM symbols 204, 206, thereby maintaining a frequency-first, time-second allocation scheme, as illustrated in FIG. 2C.

In one example, as shown in FIG. 2C, a bandwidth-limited UE 220 may receive a portion of the RMSI in the punctured resource blocks 202a, 202b in one or more OFDM symbols 204, 206. Additionally, as illustrated in FIG. 2C, the wideband UE 225 may optionally receive a portion of the RMSI in the punctured resource blocks 202a, 202b that is retransmitted or repeated, enabling selective soft combining. Alternatively, the wideband UE 225 may disregard the additional one or more OFDM symbols 204, 206 in which the RMSI is retransmitted or repeated. In one example, from the BS transmission perspective 215, the BS may transmit the original RMSI in the punctured resource blocks 202a, 202b, followed by one or more additional OFDM symbols 204, 206 that repeat the punctured resources intended for the bandwidth-limited UE 220.

In one example, an implicit or explicit indication may be provided to an IoT device regarding the time and/or frequency domain location of the punctured resources, thereby enabling the IoT device to insert zero-valued symbols in the punctured portions of the resources to facilitate soft decoding. In one implementation, IoT devices with limited bandwidth capabilities—such as support for only 12 PRBs or 15 PRBs—may be preconfigured with the punctured time-frequency resource locations as specified in the relevant technical specifications. In another example, a broadcast signaling message, such as the MIB or the SIB1, may indicate an index referencing a predefined table (e.g., Table 1 below) comprising one or more punctured time-frequency resource configurations. The UE may select the appropriate table index based on its bandwidth capability (e.g., 12 PRBs or 15 PRBs). In yet another example, a DCI transmission within the common search space of CORESET #0 may explicitly signal the punctured time-frequency resource configuration to the UE or index to the table containing resource location of punctured common channel. Such table can be created separately for one or more common channels.

TABLE 1
Resources within an SS/PBCH block for
PSS, SSS, PBCH, and DM-RS for PBCH

| Channel | OFDM symbol number l | Subcarrier number k |
|---|---|---|
| or | relative to the start | relative to the start |
| signal | of an SS/PBCH block | of an SS/PBCH block |
| PSS | 0 | 56, 57, . . . , 182 |
| PSS | 1 | 56, 57, . . . , 182 |
| SSS | 3 | 56, 57, . . . , 182 |
| Set to 0 | 0, 1 | 0, 1, . . . , 55, 183, 184, . . . , 239 |
| | 3 | 48, 49, . . . , 55, 183, 184, . . . , 191 |
| PBCH | 2, 4 | 0, 1, . . . , 239 |
| | 3 | 0, 1, . . . , 47, |
| | | 192, 193, . . . , 239 |
| PBCH | 5 | 49, 1, . . . , 193 |
| PBCH | 6 | 49, 1, . . . , 193 |
| DM-RS | 2, 4 | 0 + v, 4 + v, 8 + v, . . . , 236 + v |
| for | 3 | 0 + v, 4 + v, 8 + v, . . . , 44 + v |
| PBCH | | 192 + v, 196 + v, . . . , 236 + v |
| | 5, 6 | 49 + v, . . . , 193 + v |

In one example, an IoT UE may initially attempt to decode the punctured PBCH. If the decoding attempt fails, in one example, the IoT UE may transmit an uplink wake-up signal (UL WUS) to the base station (BS), requesting (re) transmission of the punctured PBCH resources. The (re) transmission of the punctured PBCH resources may be performed according to any of the options described above.

In one example, the (re) transmission of the punctured resources by the BS to IoT UEs may be triggered based on an on-demand configuration, such as in response to a UL WUS transmitted by the IoT UE. In another example, a plurality of coverage enhancement (CE) level thresholds may be configured for the IoT UE, wherein the UL WUS configuration may be associated with all CE levels or a subset of CE levels. The BS may selectively perform the (re) transmission of the punctured PBCH resources based on the configured CE level thresholds and the UL WUS request received from the IoT UE.

According to a second example, SIB0 may carry one or more types of information relevant to cell evaluation and initial access procedures. Such information may include, but is not limited to, (i) cell quality evaluation or cell selection/reselection information, (ii) cell access-related parameters, (iii) unified access control barring (UACB) information, (iv) configuration of resources for paging monitoring, and (v) emergency call support information. Additionally, SIB0 may include configuration information for UL WUS resources, as well as Type0-PDCCH common search space scheduling information associated with the reception of SIB1.

In 6G, the design of SIB0 may be unified across different device types, including eMBB UEs and LPWA-IoT UEs. In such a design, SIB0 transmissions that occupy more than 12 or 15 PRBs may be punctured to enable reception by IoT UEs with limited bandwidth capabilities. The punctured SIB0 resources may subsequently be recovered by the IoT UEs through (re) transmission of the punctured portions using additional time-domain symbols, in a manner consistent with the retransmission schemes described in the foregoing examples, while the re-transmission or repeating of the punctured resources are mapped in such a way that these resources can be within the bandwidth of bandwidth limited UE.

FIG. 2C illustrates an example of (re) transmitting punctured PBCH resources using enhanced PBCH (ePBCH), in accordance with aspects of the present disclosure. SIB0 may be transmitted via the ePBCH 208, which may be delivered immediately following the PBCH, with a time offset 210 relative to the PBCH, or through a physical downlink shared channel (PDSCH) scheduled by DCI. Information necessary for monitoring DCI transmissions in CORESET #0 and its associated common search space may be included in the MIB. The periodicity of SIB0 transmission may be the same or differ from that of the PBCH. Furthermore, to support accelerated cell acquisition, a subset of the information contained in SIB0, such as a search space monitoring table index, a CORESET #0 index, or the like, may optionally be included in the MIB.

According to a third example, 6G SIB1 design may be unified across eMBB UEs and LPWA-IoT UEs. To support IoT UEs with limited bandwidth capabilities (e.g., 12 or 15 PRBs), SIB1 transmissions occupying a greater bandwidth may be punctured. The punctured portions may then be (re) transmitted using additional time-domain symbols, enabling the IoT UEs to recover the complete SIB1 content, consistent with the (re) transmission mechanisms described in the foregoing examples.

According to a fourth example, to achieve extended coverage for IoT devices—particularly those requiring higher Maximum Coupling Loss (MCL) thresholds (e.g., +10 dB or +20 dB beyond typical eMBB coverage)—an additional repetition of the RMSI, including the PBCH, SIB0, and SIB1, may be necessary. The repeated RMSI transmissions may be configured to use reduced transmission bandwidths, such as 12 or 15 PRBs, which are compatible with the narrower bandwidth capabilities of LPWA-IoT UEs. Furthermore, in one example, the transmission bandwidth of the repeated RMSI intended specifically for LPWA operation may differ from that used for the initial RMSI transmission and its associated repetitions.

In scenarios where a plurality of IoT-specific bandwidths (e.g., both 12 PRBs and 15 PRBs) are supported, the BS may elect to transmit the repeated RMSI using the larger of the supported bandwidths, such as 15 PRBs. In such cases, IoT UEs that support only a smaller bandwidth (e.g., 12 PRBs) may receive a punctured version of the RMSI, including punctured PBCH, SIB0, and SIB1 transmissions.

In one example, IoT UEs with support limited to 12 PRBs may be preconfigured with information from the specification detailing the time-frequency locations of the punctured portions of the repeated RMSI channels. In another example, the MIB or SIB1 may indicate an index referencing a predefined table that specifies punctured time-frequency resource patterns. The UE may select an appropriate table entry based on its supported bandwidth, such as 12 PRBs or 15 PRBs. In yet another example, a DCI transmission within the common search space of CORESET #0 may explicitly indicate the time-frequency resource locations of the punctured RMSI channels or index to the table containing the resource location of the punctured common channel. In one example, such table can be created separately for one or more common channels.

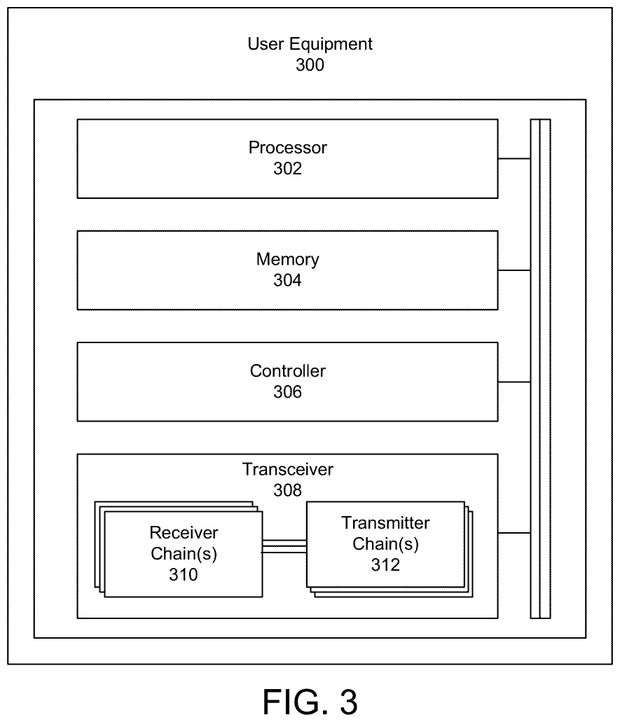

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the UE functions described herein (e.g., executing, by the processor 302, instructions stored in the memory 304). Accordingly, the processor 302 may support wireless communication at the UE 300 in accordance with examples as disclosed herein.

In one example, the UE 300 is configured to receive a first portion of a transmission from a BS in a resource of a common channel, the UE having a threshold bandwidth that is less than a reception channel bandwidth of the common channel, receive a second portion of the transmission from the BS in a second resource of a second common channel, the second portion of the transmission received on one or more symbols of the second common channel, and combine the first and second portions of the transmission.

The controller 306 may manage input and output signals for the UE 300. The controller 306 may also manage peripherals not integrated into the UE 300. In some implementations, the controller 306 may utilize an operating system (OS) such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding/processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

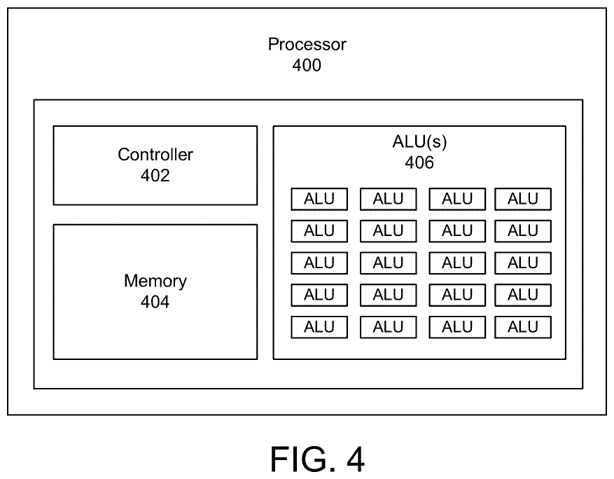

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

In various examples, the processor 400 may support wireless communication of a UE, in accordance with examples as disclosed herein. In other examples, the processor 400 may support wireless communication of a RAN entity, in accordance with examples as disclosed herein.

In one example, the processor 400 is configured to receive a first portion of a transmission from a BS in a resource of a common channel, the UE having a threshold bandwidth that is less than a reception channel bandwidth of the common channel, receive a second portion of the transmission from the BS in a second resource of a second common channel, the second portion of the transmission received on one or more symbols of the second common channel, and combine the first and second portions of the transmission.

In one example, the processor 400 is configured to configure one or more UE to receive common channel transmissions, wherein the one or more UE are of different types that have different threshold bandwidths, identify one or more common channels that have reception channel bandwidths that are less than the threshold bandwidths of the different types of UE, transmit a transmission to the one or more UE in a resource of a common channel of the one or more common channels, and retransmit at least a portion of the transmission in a second resource of a second common channel to one or more UE that have a threshold bandwidth that is less than the reception channel bandwidth of the common channel.

In one example, the at least a portion of the transmission that is retransmitted includes one or more punctured resources of the common channel. In one example, the one or more punctured resources include RMSI, CORESET #0, or a combination thereof. In one embodiment, the processor 400 is configured to transmit minimum system information in a physical layer broadcast channel and one or more system information blocks in a physical layer downlink shared channel.

In one example, the at least a portion of the transmission comprising the one or more punctured resources is retransmitted in one or more OFDM symbols of the second common channel. In one example, the one or more OFDM symbols include OFDM symbols that immediately follow the common channel. In one example, the one or more OFDM symbols include OFDM symbols with a configured time offset from the one or more punctured resources.

In one example, the processor 400 is configured to maintain and transmit a mapping of the one or more punctured resources of the common channel to one or more symbols of the second common channel. In one example, the processor 400 is configured to map the one or more punctured resources starting from a lowest resource that corresponds to a lowest resource block of the one or more punctured resources.

In one example, the processor 400 is configured to transmit an indication of a time or frequency location of the one or more punctured resources. In one example, the processor 400 is configured to retransmit the one or more punctured resources in response to a request from a UE. In one example, the common channel includes a PDSCH that is scheduled using DCI. In one example, the processor 400 is configured to retransmit the at least a portion of the transmission to UE that has a MCL that is less than a threshold MCL.

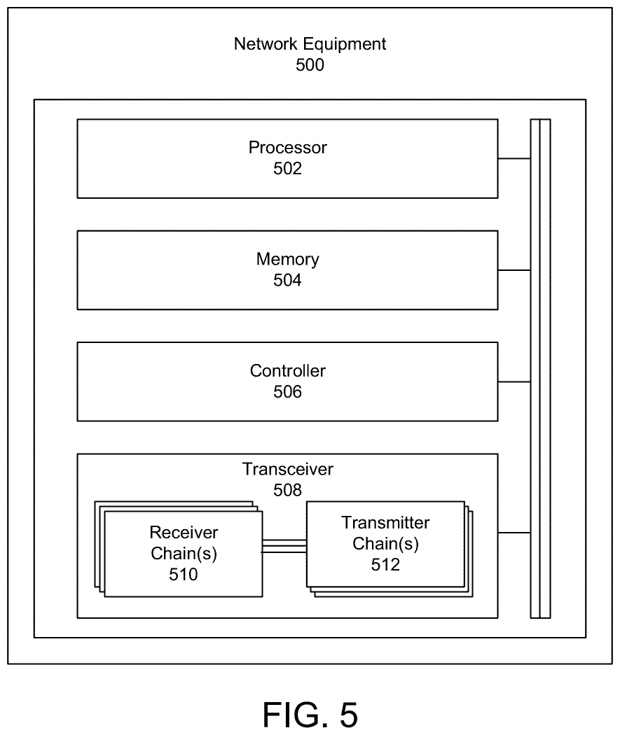

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the RAN functions described herein (e.g., executing, by the processor 502, instructions stored in the memory 504). For example, the processor 502 may support wireless communication at the NE 500 in accordance with examples as disclosed herein.

In one example, the NE 500 is configured to configure one or more UE to receive common channel transmissions, wherein the one or more UE are of different types that have different threshold bandwidths, identify one or more common channels that have reception channel bandwidths that are less than the threshold bandwidths of the different types of UE, transmit a transmission to the one or more UE in a resource of a common channel of the one or more common channels, and retransmit at least a portion of the transmission in a second resource of a second common channel to one or more UE that have a threshold bandwidth that is less than the reception channel bandwidth of the common channel.

In one example, the at least a portion of the transmission that is retransmitted includes one or more punctured resources of the common channel. In one example, the one or more punctured resources include RMSI, CORESET #0, or a combination thereof. In one embodiment, the NE 500 is configured to transmit minimum system information in a physical layer broadcast channel and one or more system information blocks in a physical layer downlink shared channel.

In one example, the at least a portion of the transmission comprising the one or more punctured resources is retransmitted in one or more OFDM symbols of the second common channel. In one example, the one or more OFDM symbols include OFDM symbols that immediately follow the common channel. In one example, the one or more OFDM symbols include OFDM symbols with a configured time offset from the one or more punctured resources.

In one example, the NE 500 is configured to maintain and transmit a mapping of the one or more punctured resources of the common channel to one or more symbols of the second common channel. In one example, the NE 500 is configured to map the one or more punctured resources starting from a lowest resource that corresponds to a lowest resource block of the one or more punctured resources.

In one example, the NE 500 is configured to transmit an indication of a time or frequency location of the one or more punctured resources. In one example, the NE 500 is configured to retransmit the one or more punctured resources in response to a request from a UE. In one example, the common channel includes a PDSCH that is scheduled using DCI. In one example, the NE 500 is configured to retransmit the at least a portion of the transmission to UE that has a MCL that is less than a threshold MCL.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

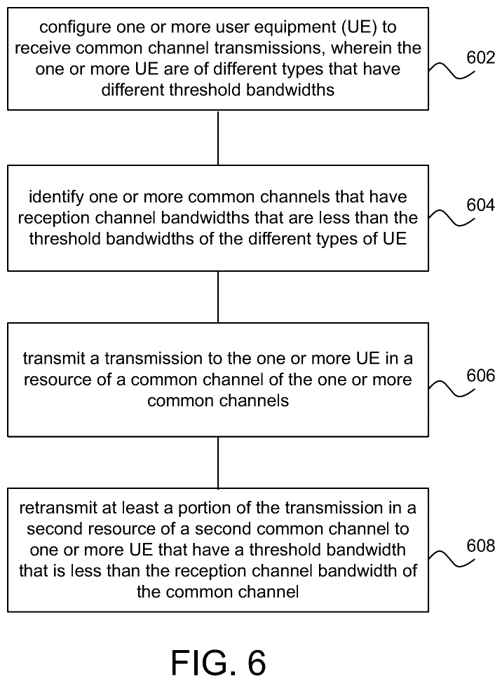

FIG. 6 illustrates a flowchart of a method performed by a NE 500 in accordance with aspects of the present disclosure. The operations of the method may be implemented by an NE 500 as described herein. In some implementations, the NE 500 may execute a set of instructions to control the function elements of the NE 500 to perform the described functions.

At step 602, the method may configure one or more UE to receive common channel transmissions, wherein the one or more UE are of different types that have different threshold bandwidths. The operations of step 602 may be performed in accordance with examples as described herein. In some implementations, aspects of the operations of step 602 may be performed by an NE 500, as described with reference to FIG. 5.

At step 604, the method may identify one or more common channels that have reception channel bandwidths that are less than the threshold bandwidths of the different types of UE. The operations of step 604 may be performed in accordance with examples as described herein. In some implementations, aspects of the operations of step 604 may be performed by an NE 500, as described with reference to FIG. 5.

At step 606, the method may transmit a transmission to the one or more UE in a resource of a common channel of the one or more common channels. The operations of step 606 may be performed in accordance with examples as described herein. In some implementations, aspects of the operations of step 606 may be performed by an NE 500, as described with reference to FIG. 5.

At step 608, the method may retransmit at least a portion of the transmission in a second resource of a second common channel to one or more UE that have a threshold bandwidth that is less than the reception channel bandwidth of the common channel. The operations of step 608 may be performed in accordance with examples as described herein. In some implementations, aspects of the operations of step 608 may be performed by an NE 500, as described with reference to FIG. 5.

It should be noted that the method described herein describes one possible implementation, and that the operations and the steps may be rearranged or otherwise modified and that other implementations are possible.

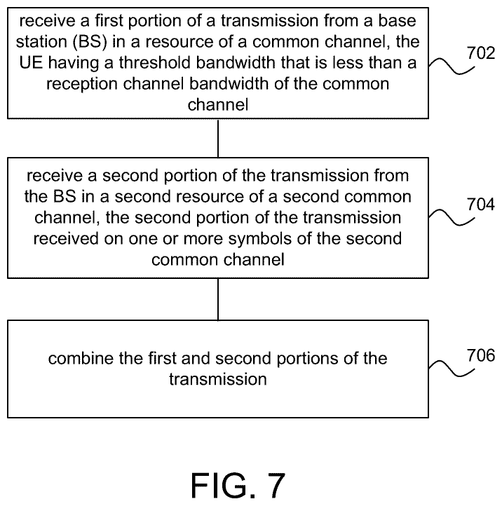

FIG. 7 illustrates a flowchart of a method performed by a UE 300 in accordance with aspects of the present disclosure. The operations of the method may be implemented by a UE 300 as described herein. In some implementations, the UE 300 may execute a set of instructions to control the function elements of the UE 300 to perform the described functions.

At step 702, the method may receive a first portion of a transmission from a BS in a resource of a common channel, the UE having a threshold bandwidth that is less than a reception channel bandwidth of the common channel. The operations of step 702 may be performed in accordance with examples as described herein. In some implementations, aspects of the operations of step 702 may be performed by a UE 300, as described with reference to FIG. 3.

At step 704, the method may receive a second portion of the transmission from the BS in a second resource of a second common channel, the second portion of the transmission received on one or more symbols of the second common channel. The operations of step 704 may be performed in accordance with examples as described herein. In some implementations, aspects of the operations of step 704 may be performed by a UE 300, as described with reference to FIG. 3.

At step 706, the method may combine the first and second portions of the transmission. The operations of step 706 may be performed in accordance with examples as described herein. In some implementations, aspects of the operations of step 706 may be performed by a UE 300, as described with reference to FIG. 3.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station (BS) for wireless communication, comprising:
at least one memory; and
at least one processor coupled with the at least one memory and configured to cause the BS to:
configure one or more user equipment (UE) to receive common channel transmissions, wherein the one or more UE are of different types that have different threshold bandwidths;
identify one or more common channels that have reception channel bandwidths that are less than the threshold bandwidths of the different types of UE;
transmit a transmission to the one or more UE in a resource of a common channel of the one or more common channels; and
retransmit at least a portion of the transmission in a second resource of a second common channel to one or more UE that have a threshold bandwidth that is less than the reception channel bandwidth of the common channel.

2. The BS of claim 1, wherein the at least a portion of the transmission that is retransmitted comprises one or more punctured resources of the common channel.

3. The BS of claim 2, wherein the one or more punctured resources comprise remaining minimum system information (RMSI), control resource set (CORESET) #0, or a combination thereof.

4. The BS of claim 3, wherein the at least one processor is configured to cause the BS to transmit minimum system information in a physical layer broadcast channel and one or more system information blocks in a physical layer downlink shared channel.

5. The BS of claim 2, wherein the at least a portion of the transmission comprising the one or more punctured resources is retransmitted in one or more Orthogonal Frequency Division Multiplexing (OFDM) symbols of the second common channel.

6. The BS of claim 5, wherein the one or more OFDM symbols comprise OFDM symbols that immediately follow the common channel.

7. The BS of claim 6, wherein the one or more OFDM symbols comprise OFDM symbols with a configured time offset from the one or more punctured resources.

8. The BS of claim 2, wherein the at least one processor is configured to cause the BS to maintain and transmit a mapping of the one or more punctured resources of the common channel to one or more symbols of the second common channel.

9. The BS of claim 8, wherein the at least one processor is configured cause the BS to map the one or more punctured resources starting from a lowest resource that corresponds to a lowest resource block of the one or more punctured resources.

10. The BS of claim 2, wherein the at least one processor is configured to cause the BS to transmit an indication of a time or frequency location of the one or more punctured resources.

11. The BS of claim 2, wherein the at least one processor is configured to cause the BS to retransmit the one or more punctured resources in response to a request from a UE.

12. The BS of claim 1, wherein the common channel comprises a physical downlink shared channel (PDSCH) that is scheduled using downlink control information (DCI).

13. The BS of claim 1, wherein the at least one processor is configured to cause the BS to retransmit the at least a portion of the transmission to UE that has a maximum coupling loss (MCL) that is less than a threshold MCL.

14. A method of a base station (BS), comprising:
configuring one or more user equipment (UE) to receive common channel transmissions, wherein the one or more UE are of different types that have different threshold bandwidths;
identifying one or more common channels that have reception channel bandwidths that are less than the threshold bandwidths of the different types of UE;
transmitting a transmission to the one or more UE in a resource of a common channel of the one or more common channels; and
retransmitting at least a portion of the transmission in a second resource of a second common channel to one or more UE that have a threshold bandwidth that is less than the reception channel bandwidth of the common channel.

15. The method of claim 14, wherein the at least a portion of the transmission that is retransmitted comprises one or more punctured resources of the common channel.

16. The method of claim 15, wherein the one or more punctured resources comprise remaining minimum system information (RMSI), control resource set (CORESET) #0, or a combination thereof.

17. The method of claim 16, further comprising transmitting minimum system information in a physical layer broadcast channel and one or more system information blocks in a physical layer downlink shared channel.

18. The method of claim 15, wherein the at least a portion of the transmission comprising the one or more punctured resources is retransmitted in one or more Orthogonal Frequency Division Multiplexing (OFDM) symbols of the second common channel.

19. A user equipment (UE) for wireless communication, comprising:
at least one memory; and
at least one processor coupled with the at least one memory and configured to cause the UE to:
receive a first portion of a transmission from a base station (BS) in a resource of a common channel, the UE having a threshold bandwidth that is less than a reception channel bandwidth of the common channel;
receive a second portion of the transmission from the BS in a second resource of a second common channel, the second portion of the transmission received on one or more symbols of the second common channel; and
combine the first and second portions of the transmission.

20. A method of a user equipment (UE), comprising:
receiving a first portion of a transmission from a base station (BS) in a resource of a common channel, the UE having a threshold bandwidth that is less than a reception channel bandwidth of the common channel; and
receiving a second portion of the transmission from the BS in a second resource of a second common channel, the second portion of the transmission received on one or more symbols of the second common channel; and
combining the first and second portions of the transmission.
